(19) United States
(12) Patent Application Publication
(10) Pub. No.: US 2002/0003195 A1
(43) Pub. Date: Jan. 10, 2002

(54) Electric wire insulator and fastener

(76) Inventor: Matt McDowell, Enterprise, OR (US)

Correspondence Address: LIEBLER, IVEY & CONNOR, P.S., The Edison Professional Building, 1141 North Edison, Suite C, P.O. Box 6125, Kennewick, WA, 99336-0125, US

(21) Appl. No.: 09/877,542

(22) Filed: Jun. 8, 2001

Related U.S. Application Data
(63) Continuation-in-part of application No. 09/454,217, filed on Dec. 9, 1999.

(51) Int. Cl. F16B 15/00

(52) U.S. Cl. 248/71

(57) ABSTRACT

An apparatus which attaches to a pole, post or panel providing a means of installing electrical fencing. The apparatus comprising a strap capable of interconnection around a pipe or panel element, a member extending from the strap terminating in a fixture receiving an electrical wire.

### FIELD OF THE INVENTION

The present invention relates generally to fasteners, and in particular, to fasteners suitable for the use with an insulator in supporting electrically charged wires in a position where the wire is insulated from the ground and from the fence posts or panels supporting the wire.

### BACKGROUND OF THE INVENTION

A variety of apparatus' are known in the prior art which are directed toward fasteners. The prior art has disclosed rigid mounting devices attached to line posts for holding an electrified wire to form an electric fence. However, such devices have not been usable where the fence posts ends are not accessible.

In the equine and farming industry it is desirable to keep cattle or mares and stallions separated. Portable or permanent stock panels are used to build corrals that divide the animals. These stock panels are typically made of tubing of either 18 gauge or 20 gauge with the tubing welded together to form a panel that is five feet high and between eight to twelve feet long. Additionally, many gates are made of these panels. These panels can be held to an adjoining panel by drop pins to form a corral. These panels are expensive. In order to resist the efforts of the cattle or stallions that will try to come over the top of a panel, bump into a panel or otherwise ruin a panel, it is desirable to install hot wiring along the top rung of the panel.

It will be further appreciated by those skilled in the art that there was no way to affix hot wires to this tubing without using screws or drilling into the tubing or making a bracket with sheet metal which is a time consuming process.

U.S. Pat. No. 4,883,923 to Langlie refers to insulators intended for attachment to round metal posts. U.S. Pat. No. 4,263,477 to Wilson describes mounting means without reference to the particular different applications available. U.S. Pat. No. 3,654,383 to Wilson shows principally holes through which a nail is inserted into a post. U.S. Pat. No. 3,297,820 to Kew shows a screw into a wooden post. U.S. Pat. No. 4,771,137 to Thompson shows nails and snaps or clip forms; in particular in that the structure at 50 forms a clip with a jaw which is pushed over or around a pipe. U.S. Pat. No. 5,063,274 to Johnson refers to supporting and connecting means without reference to tie wrap or clip. U.S. Pat. No. 4,214,349 to Munch shows an improved tie wrap. U.S. Pat. No. 4,557,024 to Roberts et al is representative of a fastening means pertinent to this invention.

The patents referred to herein are provided herewith in an Information Disclosure Statement in accordance with 37 CFR 1.97.

### SUMMARY OF THE INVENTION

In general it is an object of this invention to provide a fastener which can be installed without access to an end of an article. An additional object of the invention is to provide a fastener that is simple, easy and rapid to install. Another object of the invention is to provide a fastener that can be mass produced at a relatively low cost, thereby encouraging its widespread use by farmers and ranchers. This Continuation-in-Part application additionally reveals an alternative embodiment for affixing electrical wire at the terminal of an insulating post or member.

Still another object of the invention is to provide a fastener that will not only securely hold in place various types of electric fence conductors, but which can be attached to any variety of fence posts and panels commonly encountered on farms, ranches and ranges. In this regard, the fastener of the present invention lends itself readily to incorporation with wooden fence posts, round metal posts, and also to T-shaped metal posts. More specifically, an aim of the invention is to provide a fastener having means incorporated therein for mounting on a fence post or a panel where there is no free end.

It is a further object to provide a fastener having mounting means for an electrical wire which securely maintains and supports the wire in the proper position. The present invention discloses a fastener with a member extending from the fastener. The preferred embodiment of the invention is a tie wrap having a plastic fastener member formed there within. An additional embodiment employs the same or a similar fastener disclosed in U.S. Pat. No. 4,557,024 as the means of affixing the insulating structure to a post and or panel.

### BRIEF DESCRIPTION OF THE DRAWINGS

The foregoing and other features and advantages of the present invention will become more readily appreciated as the same become better understood by reference to the following detailed description of the preferred embodiment of the invention when taken in conjunction with the accompanying drawings, wherein:

FIG. 1 is a perspective view of the fastener showing the strap, and member with fixture. Further shown are the fastening means and rigid curved section.

FIG. 2 is a perspective view of the fastener showing the strap, inside rigid curved section, and member.

FIG. 3 is a perspective view of the fastener according to the present invention, show in operation with respect to the panel.

FIG. 4 is a front elevation of the fastener showing the means of fastening the invention to a post or a panel and showing the structure for affixing an electric wire.

FIG. 5 is a side elevation of the fastener of FIG. 4.

FIG. 6 is a section from FIG. 4 showing one insulating projection 196 and wire holder 198.

FIG. 7 is a front elevation of an alternative embodiment of the fastener showing an alternative embodiment of the structure for affixing an electric wire.

FIGS. 8 through 10 depict combinations of extensions and interconnecting teeth as fastening means to secure the strap.

### DETAILED DESCRIPTION OF THE PREFERRED EMBODIMENT(S)

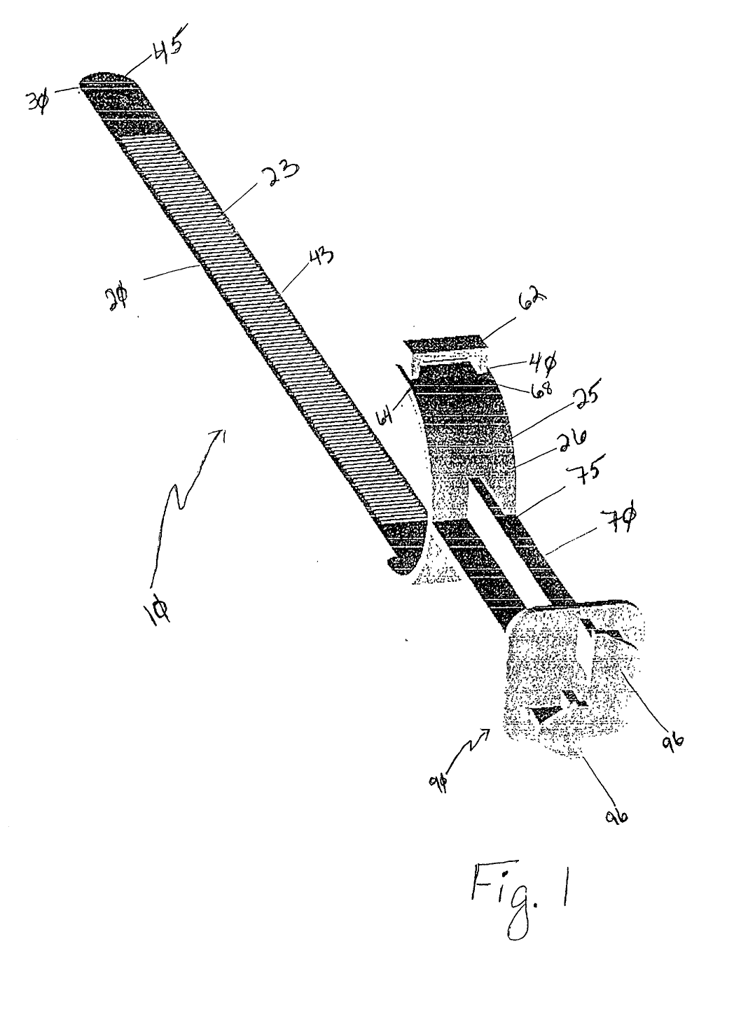

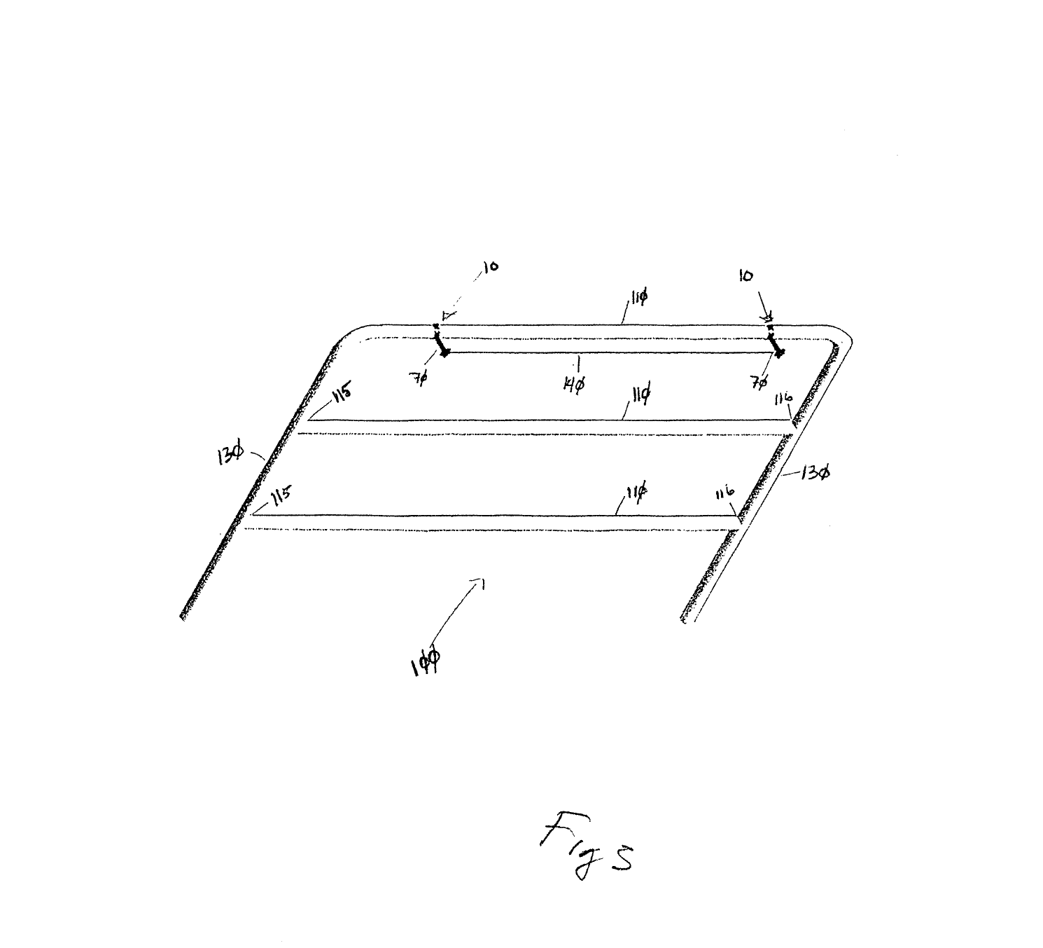

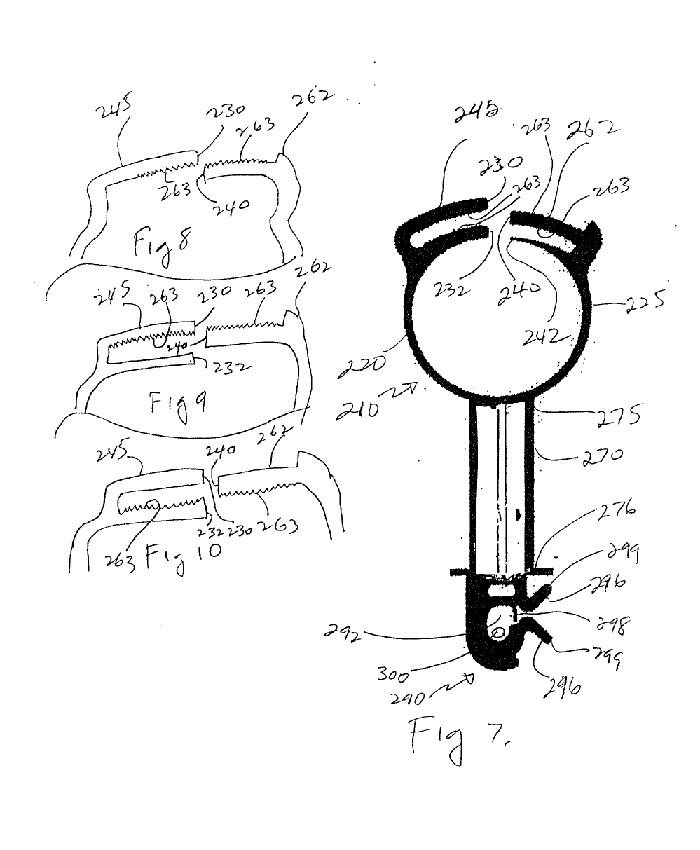

The preferred embodiment and alternative embodiments of the fastener apparatus herein disclosed is depicted in FIGS. 1 through 3 and FIGS. 4 through 10. FIG. 1 through FIG. 3 illustrate the fastener apparatus 10 which may comprise an elongated strap 20 composed of a first end 30 and a second end 40; having a fastening means, affixed to said strap 20, for connecting said first end 30 to said second end 40; a member 70, projecting outwardly from said strap 20, having a primary end 75 and a secondary end 76; the member primary end 75 affixed by means on said strap 20 intermediate said strap first 30 and second ends 40. The elongated strap and the member may be composed of a rigid or flexible material. In the preferred embodiment the elongated strap is composed of a flexible material and the member is composed of a rigid material. The fastener or member may be formed by injection molding plastic. The member may be formed integral with said strap or affixed thereto by adhesive, threads, or various other means.

The apparatus 10 may further comprise a fixture 90 located at the member secondary end 76. It is preferred that the fixture 90 is composed of plastic. The fixture 90 may be composed of other suitable materials that having electric insulating properties. If injection molded, the fixture may be formed there within the member.

This fixture 90 may comprise a securing means 92, gripping means or any other means seen as useful by those in the art. The securing means used to hold a wire, cable, line or electric tape may comprise projections which could include hooks, clasps, clips, pegs, pins, bolts or any other means that would provide securing and support to a wire, cable, line or electric tape. It will be appreciated by those in the art the various securing means for holding a wire.

The fixture 90 may have a securing means 92. In the preferred embodiment this securing means 92 would provide support for an electrified wire. In the preferred embodiment the securing means 92 consists of two projections 96 that provide friction to support a wire. The wire is placed between the two projections 96.

In the preferred embodiment a portion of the strap 20 comprises a curved rigid section 25; the member primary end 75 projects outwardly from the curved rigid section 25 and is affixed by means on the curved rigid section 25.

The fastener 10 could be tightened and adjusted to fit snug around an article whereby the first end 30 and second ends 40 of the strap 20 would overlap. The fastening means of the fastener 10 could be composed of a wide variety of known fasteners including but not limited to hook and loop elements, i.e. VELCRO, a buckle, a tie wrap, hooks and any other securing means. A buckle is a fastening for two loose ends attached to one and holding the other by a catch, latch, or clamp. Buckles are commonly used on belts and shoes.

A VELCRO type fastener may provide hooking elements capable of interlocking with loop elements. A first hook fastener may be affixed to said strap first end; and a first loop fastener may be affixed to said strap second end whereby said hook fastener is removably attached to said loop fastener. It will be understood that the interlocking pile elements may be reversed, i.e., the loop elements on the strap first end and the hook elements on the strap second end.

In the preferred embodiment of the fastener 10, the strap is a tie wrap. The fastener 10 is preferably composed of a head 62 having an elongated strap 20 of flexible material integrally formed therewith, a passage 64 through the head 62 for longitudinally receiving the strap 20; the passage 64 having an entrance end 66 and an exit end 68. The strap preferably has a plurality of longitudinally-spaced teeth 43 thereon, and terminating at a free end 45; and the strap 20 has a front side 22 and a back side 23. Preferably the fastener includes a member 70 having a primary end 75 and a secondary end 76; the primary end 75 projecting outwardly from the front side 22 between the free end 45 and the head 62.

In another embodiment, the invention discloses a panel 100 with fastener apparatus 10. The panel 100 may be composed of a horizontal article 110 having two ends 115, 116 and at least two vertical articles 130, 131; the two vertical rods 130, 131 maybe affixed by means to the horizontal rod ends 115, 116; an elongated strap 20 having a first end 30 and a second end 40; fastening means is affixed to said strap 20, for connecting said first end 30 to said second end 40, to thereby form an enclosure around the one horizontal article 110. One member 70, may project outwardly from said strap 20, said member 70 having a primary 75 and a secondary end 76; said member primary end 75 affixed by means on said strap 20 intermediate said strap first 30 and second ends 40.

The strap 20 may encircle the one horizontal rod 110. The article may be a variety of shapes including but not limited to circular, square, rectangular, I shaped, T shaped, irregular shaped or any other shape which has a periphery or perimeter. Additionally the article may be hollow whereby it made prove useful for the member to project inwardly toward the article. Examples of the article include but are not limited to fence posts, metal pipes, tubing, and any other object whereby placing a fastener may be desired. The fastener 10 can be installed on any of these articles. The preferred embodiment may be used on 1½ to 3 inch diameters.

The fastener 10 may have a fixture 90 at the secondary end 76. The fixture 90 may have a securing means 92. The securing means 92 may be used for support of electrical wires or hot tapes. In the preferred embodiment there are additional straps along the horizontal article 110 with a spacing of five to six feet between fasteners 10. A wire 140 is secured with the securing means at one fastener 10 and is extended from one fastener 10 to the next fastener 10. The fastener 10 will be securely attached to the panel 100 such that it would resist efforts of a horse or cattle that bumps into it.

The invention further discloses a method of applying the fastener around an article, comprising the steps of placing the fastener near the article, the article having a periphery, the at least one member outwardly from said article; and securing said strap first and second ends 30,40 around said periphery thereby securing the fastener in place. The fastener is installed without any tools or secondary fastening devices.

In another embodiment of the method of applying the fastener around an article, said member is projecting outwardly from said article. Alternatively, there may arise an instance, where said member is applied where the member would project inwardly toward said article.

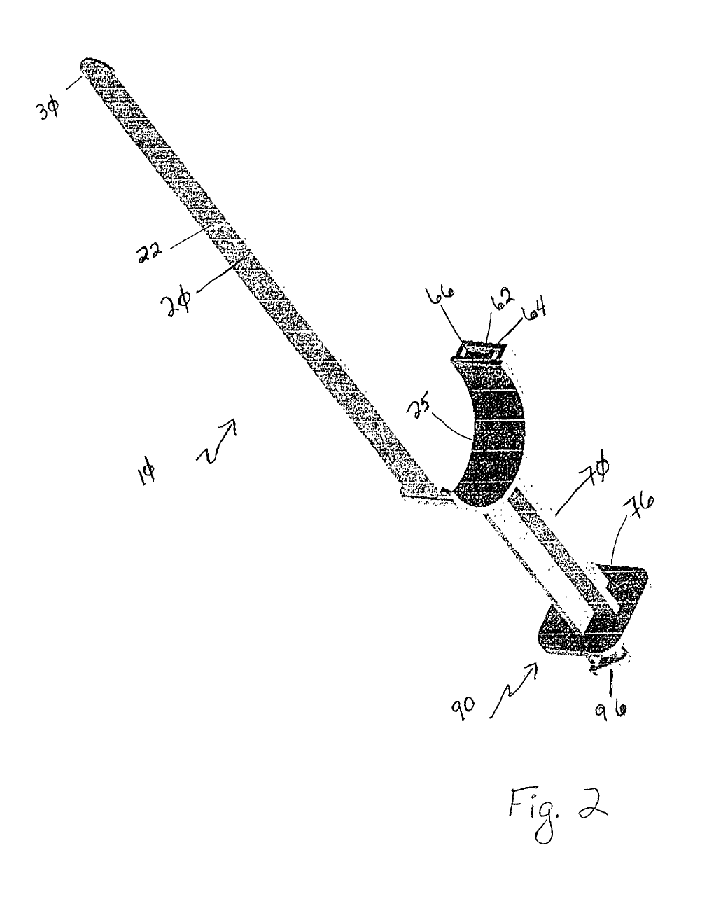

FIG. 4 through FIG. 7 illustrate an alternative embodiment of the apparatus 10 and fixture 90. Depicted in FIG. 4 through 7 is a fastener apparatus 210 and connecting fixture 290 providing the structure of FIGS. 1 through 3, regarding the affixing of a structure to a pole and the affixing of a wire, including an electrical wire, to the apparatus. FIGS. 4 through 7 illustrate an alternative embodiment showing the same or a similar affixing means, as a fastener apparatus 210, for affixing the invention to a post, as seen in U.S. Pat. No. 4,557,024. The fastener apparatus 210, seen in FIG. 4, which may comprise a strap 220 having a first strap end 245 which consists of an upper extension 230 and a lower extension 232 while a second strap end 262 has an upper extension 240 and a lower extension 242. Strap end 262 has two sets of large teeth a263, one row on each side of extension 240. The space between extensions 230 and 232 is dimensioned to receive extension 240 of strap end 262. The lower side of extension 230 and the upper side of extension 232, on first strap end 245, also have large teeth 263. When the strap ends 245 and 262 are brought together, extensions 230 and 232 of first strap end 245 receive extension 240 of strap end 262, and respective extensions 240 and 242 of strap end 262 correspondingly receive extension 232 as will be appreciated by viewing FIG. 4. Those of ordinary skill in the mechanical arts will appreciate that the large teeth 263 of extensions 240, 230 and 232 may be serrated or formed in a rachet formation such that the large teeth 263 of extension 240 are slidably received over the large teeth 262 of extensions 230 and 232 but where the large teeth 263 are angled so as to lock or securely engage the large teeth 263 of the opposing extensions thereby allowing the strap 210 to be securely engaged around a horizontal article 110 or pipe or a vertical articles 130, 131 or rod as depicted in FIG. 3. It will also be noted that the ratchet type of interconnection may be accomplished by providing a single set of teeth at each of the first and the second ends formed such that the teeth of the first end will interconnect with the teeth of the second end, e.g., a single set of teeth 263 at the lower side of extension 230 and a single set of teeth 263 at the upper side of extension 240. The receiving of extension 240 by extensions 230 and 232 will allow the interconnection of teeth so situated. Those of ordinary skill will recognize that alternative teeth arrangements include a single set of teeth 263 at the upper side of extension 232 and a single set of teeth 263 at the lower side of extension 240; alternatively, a single set of teeth may be positioned at the upper side of extension 242 with a single set of teeth at the lower side of extension 232. It will also be appreciated that a single extension 240 or 242 at the end 262 may be ratchet or teeth interconnected with a single extension 230 or 232 at end 245. It will also be appreciated that a single extension 240 or 242 at the end 262 may be ratchet or teeth interconnected with and between extensions 230 or 232 at end 245 and alternatively that a single extension 230 or 232 at the end 245 may be ratchet or teeth interconnected with and between extensions 240 and 242 at end 262. The choice of materials, including plastics and Nylon, may dictate, by the stiffness or rigidity or semi-rigidity characteristics of the materials, the number of extensions at each of the strap ends 245 and 262 required to provide a secure interconnection. Alternative arrangements of extensions and teeth at the strap ends 245 and 262 are depicted in FIGS. 8 through 10.

Also depicted in FIGS. 4 through 7 are alternative forms of a connecting fixture 290, for receiving and securing an electrical wire, located at a member secondary end 276. Again, the structure of this alternative embodiment is parallel to that of the preferred embodiment. Both the preferred embodiment, as depicted in FIGS. 1 through 3, and alternative embodiments, depicted in FIG. 4 through 10, provide fastener 10 and fastener apparatus 210 comprised of an elongated strap 20 or strap 220. The strap 20 has a first and second end 30, 40 or first strap end and second strap end 245, 262. Fastening means is provided at the first and second ends 30, 40 and first strap end and second strap end 245, 262 permitting the securing or joining of the said ends 30, 40 or first strap and second strap ends 245, 262 to secure the apparatus to a post. Extending from the elongated strap 20 or strap 220 is a member 70 or connecting member 270. The member 70 or connecting member 270 projects from the affixing means, i.e., the elongated strap 20 or strap 220, as a structure which removes or distances the eventually connected electrical wire 300 from the vicinity of the generally metal panel 100. The panel 100 is generally comprised of generally at least a horizontal article 110 having two ends 115, 116 and at least two vertical articles 130, 131 where the vertical and horizontal articles are generally pipes, rods, poles or posts of metal construction.

The preferred and alternative embodiments provide at the member 70 and connecting member 270, at the position distal to the elongated strap 20 or strap 220, a securing means for securing an electrical wire 300. The member 70 or connecting member 270 or the securing means for securing an electrical wire 300 will have electrical insulating properties. Thus the preferred and alternative embodiments provide a structure which attaches to a pole, post or panel 100 providing a means of installing electrical fencing to panels commonly used.

The alternative embodiment provides a connecting member 270, projecting outwardly from said strap 220, having a primary end 275 and a secondary end 276; the connecting member primary end 275 affixed by means on said strap 220 intermediate said strap first 245 and second ends 262. The elongated strap 20 and strap 220 are generally composed of a flexible or semi-flexible material including plastics and Nylon. The member 70 and connecting member 270 may be composed of a rigid or flexible material having rigidity sufficient to retain the electric wire 300 out of contact with the generally metal panel 100. In the preferred and alternative embodiments the elongated strap or strap is composed of a flexible material and the member or connecting member is composed of a rigid material. The fastener 10 and or fastener apparatus 210 may be formed by plastic molding techniques including injection molding. The member 70 and or connecting member 270 may be formed integral with said elongated strap 20 or strap 220 or affixed thereto by adhesive, threads, rivets and other means which will be appreciated by those of ordinary skills in the art.

The connecting fixture 290 and each embodiment herein will be composed of a plastic. However, it will be recognized that the one of the components of the fastener 10 or fastener apparatus 210 will be an electrical insulator. Thus requisite insulating properties will be found in the strap, member and or fixture components. The connecting fixture 290 may be composed of materials having electrically insulating qualities. However, the serrated, rachet or large teeth 263 structures preferred, in this embodiment, for strap ends 245 and 262 will generally be composed of Nylon or such other material which will have sufficient strength or hardness so as to resist erosion as the teeth 263 of extensions 230, 232, 240 and 242 are engaged and disengaged.

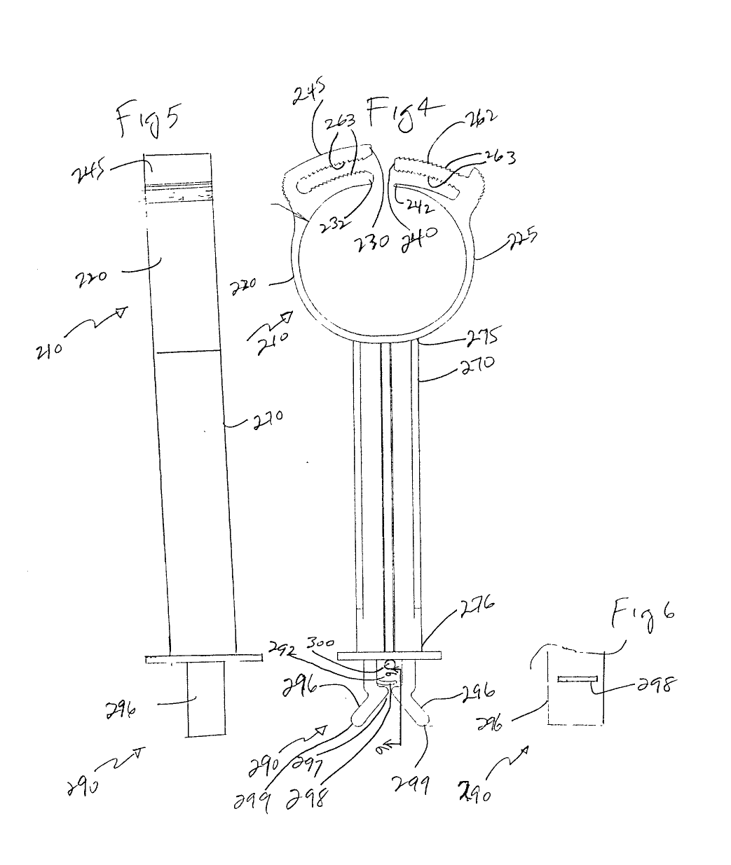

The alternative connecting fixture 290, in the alternative embodiment, depicted in FIG. 4 and 7, is the structure of at least two projections or arms 296 extending from the connecting member secondary end 276 and forming a V shape or jaw shape to guide and receive an electrical wire 300. The arms 296 terminate, distal from the connecting member secondary end 276, in arm ends 299. The arms 296, proximal the connecting member secondary end 276, in combination with the connecting member secondary end 276, forms a space which will receive a wire and which is denominated a wire space 292 sufficient to receive an electrical wire 300. The at least two arms 296 form, intermediate the connecting member secondary end 276 and the arm ends 299, a V shaped entrance denominated an entrance point 297. The opening of the “V” is at the arm ends 299. The tip or point or apex of the V forms the entrance point 297, where the “V” tip or apex would join. The arms 296, at the entrance point 297, are not joined. The arms 296, at the entrance point 297, will allow, by a spring function of the material forming the arms 296, a separation of the arms 296 sufficient to allow passage of an electrical wire 300 at the entrance point 297. The material forming the projections or arms 296 has a spring function which will allow the respective arms 296 to move apart, upon forcing an electrical wire against the arms 296 at the point where the respective arms 296 are proximal to each other, the entrance point 297, to form the respective legs of the “V”. The structure depicted in FIG. 4 and FIG. 7 additionally shows a restraint or catch 298, also having a spring function, which will be depressed upon insertion of an electrical wire 300 with the catch 298 returning to its resting position following insertion of an electrical wire 300 into the wire space 292. The restraint or catch 298 in its resting position blocks the entrance point 297 preventing removal of the electrical wire 300 from the wire space 292. The catch 298 projects from at least one arm 296 into the wire space and will generally be formed intergal with the formation of the fastener apparatus 210. It will be appreciated that the connecting fixture 290 may be formed such that the opening of the “V” at the arm ends 299 may have a variety of orientations including orthognal, as illustrated in FIG. 4, to the connecting member or at other orientations, as illustrated in FIG. 7.

It will be appreciated by those in the art that there is a desire to attach fasteners to fence posts and pipes where there is no access to an end. Articles that the fastener may be attached to are metal pipes, fences posts, poles, or any other article where there is no access to the ends.

While a preferred embodiment of the present invention has been shown and described, it will be apparent to those skilled in the art that many changes and modifications may be made without departing from the invention in its broader aspects. The appended claims are therefore intended to cover all such changes and modifications as fall within the true spirit and scope of the invention.

I claim:

1. A fastener comprising:
a. an elongated strap having a first end and a second end;
b. fastening means, affixed to said strap, for connecting said first end to said second end;
c. at least one member, projecting outwardly from said strap, having at least one primary end and at least one secondary end; said at least one member primary end affixed by means on said strap intermediate said strap first and second ends.

2. A fastener of claim 1 further wherein:
a. at least one fixture at said at least one member secondary end.

3. A fastener of claim 2 wherein:
a. said at least one fixture comprises at least one securing means.

4. A fastener of claim 2 wherein:
a. said fixture is composed of an electric insulating material.

5. A fastener of claim 2 wherein:
a. said fixture is composed of plastic.

6. A fastener of claim 1 further wherein:
a. a portion of said strap comprises a curved rigid section; said at least one member primary end projecting outwardly, affixed by means on said curved rigid section.

7. A fastener of claim 1 wherein:
a. said fastening means comprises a first hook fastener affixed to said strap first end; and
b. a first loop fastener is affixed to said strap second end whereby said hook fastener is removably attached to said loop fastener.

8. A fastener of claim 1 wherein:
a. said fastening means comprises a buckle.

9. A fastener of claim 1 wherein:
a. said strap is a tie wrap.

10. A fastener of claim 1 wherein:
a. said fastening means is at least one hook and at least one opposite hook, said at least one hook is affixed by means to said strap first end; said at least one opposite hook is affixed by means to said strap second end.

11. A panel with fastener comprising:
a. at least one horizontal article having two ends and at least two vertical articles, said at least two vertical articles are affixed by means to said horizontal rod ends;
b. an elongated strap having a first end and a second end;
c. fastening means, affixed to said strap, for connecting said first end to said second end, to thereby form an enclosure around said at least one horizontal article;
d. at least one member, projecting outwardly from said strap, having at least one primary end and at least one secondary end; said at least one member primary end affixed by means on said strap intermediate said strap first and second ends.

12. A panel of claim 11 wherein:
a. said at least one member is projecting outwardly from said article.

13. A panel of claim 11 further wherein:
a. said at least one fixture at said at least one member secondary end.

14. A panel of claim 12 wherein:
a. said fixture comprises at least one securing means.

15. A panel of claim 12 wherein:
a. said fixture is composed of an electric insulating material.

16. A panel of claim 12 wherein:
a. said supporting fixture is composed of plastic.

17. A panel of claim 11 further comprising:
a. a portion of said strap comprises a curved rigid section; said at least one member primary end affixed by means on said strap intermediate said strap first and second ends.

18. A panel of claim 11 wherein:
a. said fastening means comprises a first hook fastener affixed to said strap first end; and
b. a first loop fastener is affixed to said strap second end whereby said hook fastener is removably attached to said loop fastener.

19. A fastener of claim 11 wherein:
a. said fastening means comprises a buckle.

20. A fastener of claim 11 wherein:
a. said strap is a tie wrap.

21. A fastener of claim 11 wherein:
a. said fastening means is at least one hook and at least one opposite hook, said at least one hook is affixed by means to said strap first end; said at least one opposite hook is affixed by means to said strap second end.

22. A method of applying the fastener of claim 1 around an article, comprising the steps of:
a. placing the fastener near the article, the article having a periphery;
b. securing said strap first and second ends around said periphery.

23. A method of claim 22, wherein:
a. said at least one member is projecting outwardly from said article.

24. A method of claim 22, wherein:
a. said at least one member is projecting inwardly toward said article.

25. An electric wire insulator and fastener apparatus comprising:
a. a strap having a first strap end and a second strap end;
b. fastening means, affixed to said strap, for connecting said first strap end to said second strap end;
c. at least one connecting member, projecting outwardly from said strap, having at least one connecting member primary end and at least one connecting member secondary end; said at least one connecting member primary end affixed by means on said strap intermediate said strap first and second ends.
d. a connecting fixture 290 at the connecting member secondary end having means of receiving electrical wire.

26. An electric wire insulator and fastener of claim 25 further comprising:
A. fastening means at the first strap end 245 comprises at least one first extension 230 or 232; fastening means at the second strap end 262 comprises at least one second extension 240 or 242; fastening means at the first strap end at the at least one first extension forming a ratchet interconnection with fastening means at the second strap end at the at least one second extension thereby allowing the strap 210 to be securely engaged around a horizontal article 110 or pipe or vertical articles 130, 131 or rod;
B. a connecting fixture 290, for receiving and securing an electrical wire, located at the member secondary end 276.

27. The invention of claim 26 further comprising:
A. the fastening means at the second strap end which forms a ratchet interconnection with fastening means at the first strap end is comprised of fastening means at the second strap end of at least one second extension having at least one set of teeth 263 on said at least one second extension 240 or 242 interconnectably received by at least one set of teeth on the at least first extension 230 or 232;
B. the connecting fixture 290 is comprised of at least two projections or arms 296 extending from the connecting member secondary end 276; the arms 296 having arm ends 299 distal from the connecting member secondary end 276; the arms 296 spaced apart proximal the connecting member secondary end 276; at least one of the arms 296 formed, intermediate the connecting member secondary end 276 and the arm end 299 to project toward and proximal to the opposing arm 296 forming at the location of closest proximity of the at least one arm 296 to the opposing arm 296 a wire entrance point 297; the arm ends 299 spaced apart to receive an electrical wire 300; at least one arm 296 having a spring function permitting displacement of the arms 296 to allow passage of an electrical wire 300 past the wire entrance point 297 proximal the connecting member secondary end 276.

28. The invention of claim 27 further comprising:
A. the second extension comprising at least an upper second extension 240; one row of teeth formed on each of an upper and lower side of at least upper second extension 240; the first extension comprising at least upper and lower first extensions 230 and 232; the space between at least upper and lower first extensions 230 and 232 is dimensioned to receive the at least upper second extension 240; at least one of a lower side of upper first extension 230 and or a upper side of lower first extension 232 having teeth 263; first extensions 230 and 232 receive the at least an upper extension 240 of the second strap end 262; the teeth of the at least an upper second extension 240 inclined to be received and interlocked by teeth 263 of first extensions 230 and or 232 as the at least an upper second extension 240 and first extensions 230 and 232 are forced together;
B. the arms 296, proximal the member secondary end 276, in combination with the member secondary end 276, form a wire space 292 which is sized to receive an electrical wire 300; the arms 296 at the arm ends 299 forming an opening or V shape or jaw shape to guide and receive an electrical wire 300 into the wire space 292; the at least two arms 296 form, intermediate the connecting member secondary end 276 and the arm ends 299, a V shaped wire entrance; the opening of the “V” is at the arm ends 299; the tip or point or apex of the V forms a wire entrance point 297, where the “V” tip or apex would join; the arms 296, at the entrance point 297, are not joined; the arms 296, at the entrance point 297, will allow, by a spring function of the material forming the arms 296, a separation of the arms 296 sufficient to allow passage of an electrical wire 300 at the entrance point 297 to the wire space; a restraint or catch 298, having a spring function, projects from at least one arm into the wire space and is positioned such that the catch 298 will be depressed upon insertion of an electrical wire 300 at the entrance point 297 with the catch 298 returning to its resting position following insertion of an electrical wire 300 into the wire space 292.

29. The invention of claim 28 further comprising:
A. the apparatus composed of plastics.

30. The invention of claim 29 further comprising:
A. the apparatus composed of Nylon.

31. A method of applying the fastener apparatus of claim 25 around an article, comprising the steps of:
a. placing the fastener apparatus near the article, the article having a periphery;
b. securing said strap first and second ends around said periphery.

32. A method of claim 31, wherein:
a. said at least one connecting member is projecting outwardly from said article.
